(19) United States
(12) Patent Application Publication
(10) Pub. No.: US 2006/0154761 A1
(43) Pub. Date: Jul. 13, 2006

(54) Single chain continuously variable transmission

(76) Inventor: Albert W. Brown, Newport Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/033,206

(22) Filed: Jan. 11, 2005

(51) Int. Cl. F16H 61/00; F16H 55/56; B62J 13/00

(52) U.S. Cl. 474/28; 474/8; 474/18; 474/144

(57) ABSTRACT

A continuously variable transmission has a first pulley assembly and a second pulley assembly connected by a chain. At least one of the pulley assemblies has a shaft and a bulkhead secured to the shaft. The shaft has a fixed disk portion. A moveable disk portion is positioned on the shaft between the fixed disk portion and the moveable disk portion. The moveable disk portion has a portion that bears on the bulkhead and a portion that bears on the shaft. A fluid system also supplies fluid to the system to both lubricate the transmission and drive the movement of the moveable disk portion. The fluid system can be constructed to not load the shaft with any substantial axial load.

### BACKGROUND OF THE INVENTION

1. Field of the Invention

The present invention generally relates to continuously variable vehicle transmissions. More particularly, the present invention relates to hydraulic structures and pulley constructions for use in such transmissions, and more particularly, the present invention relates to the ratio changing elements.

2. Description of the Related Art

Continuously variable transmissions have great untapped potential in the field of motor vehicles. Such transmissions can allow the engine of the vehicle to be operated in its optimum power range while the transmission alters the speed of the vehicle by altering the ratio of an input shaft to an output shaft. Thus, the engine experiences improved efficiency and fuel mileage.

While gaining in popularity, continuously variable transmissions have some drawbacks. Such transmissions, for instance, generally are complicated in design and difficult to manufacture. While conceptually this type of continuously variable transmission is made of few components (i.e., belt, two pulleys, and a fluid supply system), many of the components must be specially designed and manufactured to assemble such transmissions. The design of each of the base components can be quite complicated. Moreover, assembly of the components can require a large number of man hours, which translates into higher costs for manufacturing such transmissions.

### SUMMARY OF THE INVENTION

In view of the complications associated with current designs for continuously variable transmissions, automakers have tended to use other alternatives instead of using continuously variable transmissions. One aspect of the present invention involves the recognition of the complication of construction that results from many of the prior continuously variable transmission constructions, which recognition has resulted in a comparatively simplified design of the ratio changing elements aside from the other necessary elements, such as the reverse and neutral functions, etc.

Another aspect of the present invention provides a construction in which pressurized fluid from an external source is provided to a chamber in a pulley assembly, where the chamber is defined between a bulkhead and a moveable disk and the fluid flows through a generally closed tube that is positioned within a bore formed in a shaft associated with the moveable disk and the bulkhead and, from there into the chamber through a cross hole. The bore and the tube are closely sized relative to each other such that a small controlled leakage between the bore and the tube can be used to supply fluid to moving parts of the transmission.

A further aspect of the present invention involves a construction in which the moveable disk has a first bearing surface that abuts a shaft and a second bearing surface that abuts a bulkhead with the two bearing surfaces being positioned at opposing ends of the moveable disk and a splined surface being positioned therebetween. In the illustrated embodiment, the splined surface cooperates with a splined surface defined on the bulkhead. In a presently preferred embodiment, the splined surface of the bulkhead and the surface of the bulkhead abutting the bearing surface are positioned on a skirt of the bulkhead.

Another aspect of the present invention involves a continuously variable transmission comprising a housing and a first pulley assembly and a second pulley assembly that are supported within the housing. A chain extends between the first pulley assembly and the second pulley assembly. The first pulley assembly comprises a first shaft and a first bulkhead. The first shaft comprises a first disk portion. A first moveable disk is positioned between the first bulkhead and the first disk portion. The second pulley assembly comprises a second shaft and a second bulkhead. The second shaft comprises a second disk portion. A second moveable disk is positioned between the second bulkhead and the second disk portion. The first bulkhead is secured to the first shaft such that the first bulkhead is substantially secured against rotation relative to the first shaft. The second bulkhead is secured to the second shaft such that the second bulkhead is substantially secured against rotation relative to the second shaft. A first outer bearing surface is defined between the first moveable disk and the first bulkhead and a first inner bearing surface is defined between the first moveable disk and the first shaft. A second outer bearing surface is defined between the second moveable disk and the second bulkhead and a second inner bearing surface is defined between the second moveable disk and the second shaft. A first spline connection is located between the first outer bearing surface and the first inner bearing surface. A second spline connection is located between the second outer bearing surface and the second inner bearing surface. A fluid passage extends axially through at least a portion of the first shaft and a second fluid passage extends axially through at least a portion of the second shaft. A first high pressure fluid tube extends at least part way through the first fluid passage and a second high pressure fluid tube extends at least part way through the second fluid passage. A first end of the first fluid tube contains a first plug and a first end of the second fluid tube contains a second plug.

An aspect of the present invention also involves a continuously variable transmission comprising a housing with a first pulley assembly and a second pulley assembly supported within the housing. A chain extends between the first pulley assembly and the second pulley assembly. The first pulley assembly comprises a shaft and a bulkhead. The shaft comprises a disk portion. A moveable disk is positioned between the bulkhead and the disk portion. The bulkhead is secured to the shaft such that the bulkhead is substantially secured against rotation relative to the shaft. An outer bearing surface is defined between the moveable disk and the bulkhead and an inner bearing surface is defined between the moveable disk integral cylinder and the shaft. A spline connection has a location positioned relative to the axis of the shaft between the outer bearing surface and the inner bearing surface.

Another aspect of the present invention involves a continuously variable transmission comprising a housing with a first pulley assembly and a second pulley assembly supported within the housing. A chain extends between the first pulley assembly and the second pulley assembly. The first pulley assembly comprises a shaft and a bulkhead. The shaft comprises a disk portion. A moveable disk is positioned between the bulkhead and the disk portion. A fluid passage extends axially through at least a portion of the shaft. A high pressure fluid tube extends at least part way through the fluid passage and a first end of the fluid tube contains a plug.

### BRIEF DESCRIPTION OF THE DRAWINGS

These and other features, aspects and advantages of the present invention will now be described with reference to the drawings of a preferred embodiment, which embodiment is intended to illustrate and not to limit the invention. The drawings consist of three figures.

FIG. 1 is cutaway view of a transmission that is arranged and configured in accordance with certain features, aspects and advantages of the present invention.

FIG. 2 is an external end view of a housing for the transmission of FIG. 1.

FIG. 3 is an enlarged view showing a high pressure tube attached to the housing of FIG. 1.

### DETAILED DESCRIPTION OF THE PREFERRED EMBODIMENT

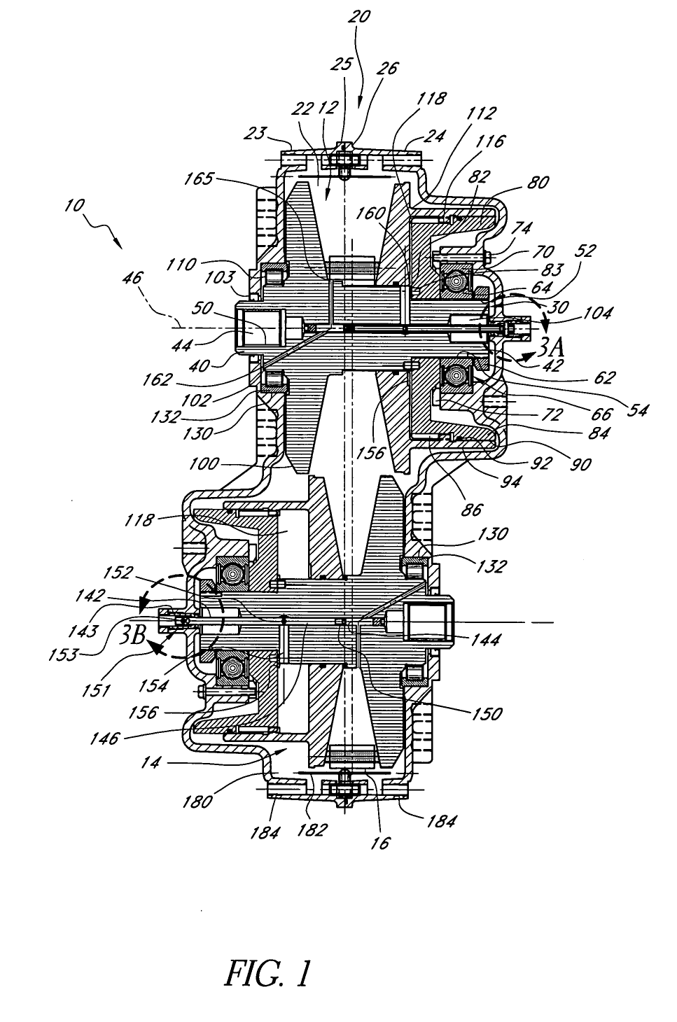

FIG. 1 illustrates an embodiment of a transmission module 10 that is arranged and configured in accordance with certain features, aspects and advantages of the present invention. While shown in the context of a single belt transmission, some of the features, aspects and advantages can be used in double belt transmissions, such as that shown in copending U.S. patent application Ser. No. ______, filed on the same date as this application, entitled IN-SERIES TWO CHAIN CONTINUOUSLY VARIABLE TRANSMISSION, and having attorney docket number BROWA.037A, which is hereby incorporated by reference in its entirety.

The transmission module 10 generally comprises an input pulley assembly 12 and an output pulley assembly 14. A chain 16 connects the input pulley assembly 12 to the output pulley assembly 14. As used herein, the term “chain” means belt, chain or other suitable forms of endless loops that can be used to transfer power from one pulley to another pulley. “Chain” also means a series of usually metal links or rings connected to or fitted into one another and used for transmission of mechanical power.

In the illustrated arrangement, the two pulley assemblies 12, 14 are substantially, if not completely, identical in construction. While the transmission module 10 can comprise pulley assemblies that are not identical, the illustrated embodiment advantageously features nearly identical pulley assemblies 12, 14 such that the number of separate components needed to assemble the transmission module 10 can be reduced, which reduces overhead and operating costs of any facility assembling and/or selling the transmission module 10.

Almost all of the moving components of the illustrated transmission module 10 are completely housed within an outer housing 20. In the illustrated arrangement, the outer housing 20 comprises two pieces, which are substantially identical to each other. While such an arrangement advantageously reduces manufacturing costs, other suitable configurations also can be used. The outer housing 20 defines a belt chamber 22 that contains the pulley assemblies 12, 14 and the chain 16. In the illustrated arrangement, the housing 20 comprises a first portion 23 and a second portion 24 that are joined together along a flange 25. The housing portions have been designed for manufacture with an aluminum permanent mold but other manufacturing techniques, and corresponding design changes, can be used. For instance, given high enough production quantities, an aluminum die casting can be used and the design can incorporate differing wall thicknesses and support ribs.

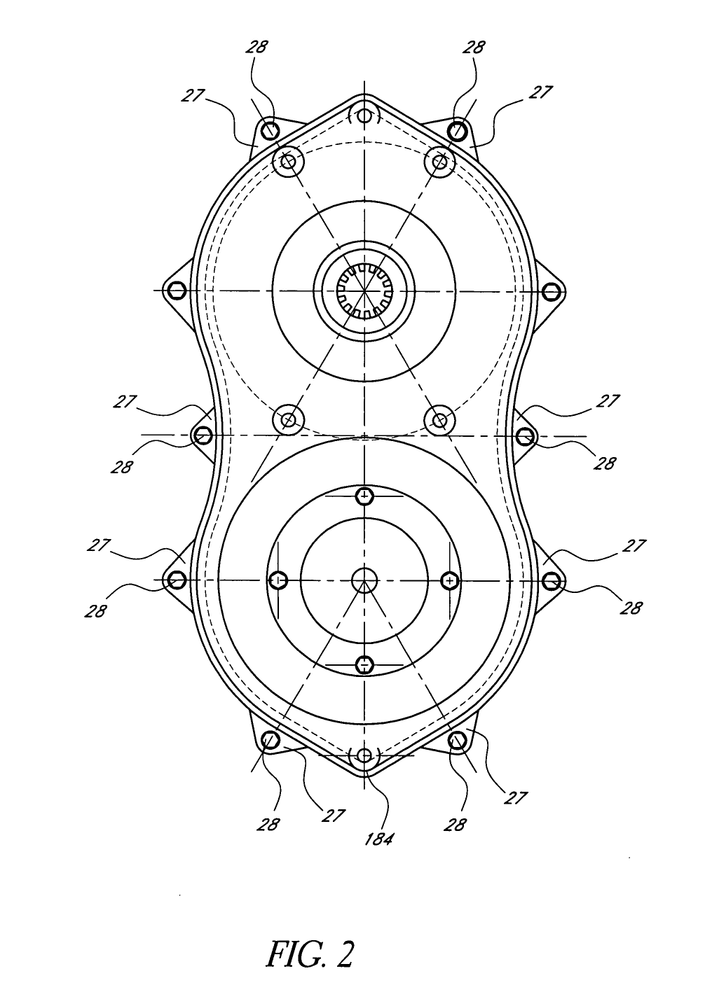

In the illustrated arrangement, the flange 25 of one of the housing halves can be provided with a groove that accommodates a seal 26. In some arrangements, a gasket or other sealing structure can be positioned within the flange and can be used to create a substantially fluid-tight belt chamber 22. The portions 23, 24 of the housing 20 can comprise bosses 27, shown in FIG. 2, which are used to secure the portions 23, 24 together. In the illustrated arrangement, the bosses can be secured together with threaded fasteners 28, shown in FIG. 2, such as bolts and nuts, but other manners of securing the portions 23, 24 together can be used.

The two portions 23, 24 of the outer housing 20 support the input pulley assembly 12 and the output pulley assembly 14. As mentioned above, the input pulley assembly 12 and the output pulley assembly 14 in the illustrated embodiment generally have identical structures. Therefore, the illustrated pulley assemblies 12, 14 will be described without reference to which pulley assembly is being described and the reference numerals may be applied to either of the pulley assemblies 12, 14 to reduce the number of reference numerals indicating elements on any single pulley assembly.

The input pulley assembly 12 is mounted on an input shaft 30. The input shaft 30 comprises a first end 40 and a second end 42. The first end 40 comprises a bore 44 that extends inward along a rotational axis 46 of the input shaft 30. The bore 44 can have any suitable configuration. In the illustrated arrangement, the bore 44 comprises splines 50 that can be used to couple the transmission to any suitable input system. For example, an output shaft from the engine can be coupled to the transmission by the splines 50. At its extreme second end, the illustrated input shaft 30 also comprises a bore 104. The bore 104 preferably extends inward through a journal portion 54 of the illustrated shaft 30.

Externally, the second end 42 of the input shaft 30 comprises a threaded region 52 and the journal region 54. A lock nut 62 engages the threaded region 52. The illustrated lock nut 62 secures an inner race 64 of a bearing 66 while a retaining ring 72 secures an outer race 70 of the bearing 66 in position. Any suitable arrangement can be used to secure the retaining ring 72 in position. In the illustrated arrangement, bolts 74 secure the ring 72 in position. Thus, in the illustrated arrangement, the retaining ring 72 and the nut 62 capture the bearing 66 in position along the journal region 54 of the input shaft 30 such that the bearing can generally resist axial thrust loads in both directions.

A bulkhead 80 is mounted to the shaft 30 and can be formed by casting, forging or any other suitable technique. In some arrangements, such as the illustrated arrangement, the input shaft 30 can comprise a locating step 82, which acts to properly position the bulkhead 80 relative to the input shaft 30 during assembly. Moreover, a plurality of pins 83, such as spring pins, for instance, can be used to secure the bulkhead 80 to the step 82 such that the bulkhead 80 and the input shaft 30 are secured together for rotation with zero backlash. In some arrangements, a spline coupling of the bulkhead 80 to the input shaft 30 can be used to rotationally secure the bulkhead 80 and the input shaft 30 with minimal backlash. In any event, the input shaft 30 preferably transfers input torque to the bulkhead 80 through the connection.

The bulkhead 80 comprises an outer skirt 84. An outer surface of the illustrated skirt 84 comprises an elongated spline region 86 and a bearing region 90. In the illustrated arrangement, a small gap is provided between the spline region 86 and the bearing region 90. Moreover, the outer surface of the skirt 84 also comprises a ring groove 92. The ring groove 92 accommodates an o-ring that is positioned to seal or substantially seal a sliding connection between the skirt 84 and a cylinder wall 94. Preferably, the ring groove 92 is positioned between the spline region 86 and the bearing region 90. The inside of the cylinder wall 94 slides along the skirt 84 during operation of the pulley assembly 12, as will be described in greater detail below.

With continued reference to FIG. 1, the first end 40 of the input shaft 30 comprises a disk portion 100 and a journal portion 102. Adjacent to the extreme first end, a seal 103 closes the opening between the housing 20 and the shaft 30. The journal portion 102 of the shaft 30 defines an inner race of a bearing 110. As such, the journal portion preferably replaces an inner race of the bearing 110 and reduces the number of components that must be assembled when building the transmission 10. In some embodiments, however, the bearing 110 can include an inner race that is secured to or positioned on the shaft 30 in any suitable manner.

Adjacent to the journal portion 102 of the illustrated shaft 30, the disk portion 100 extends radially outward from the main body of the shaft 30. The illustrated disk portion 100 is integrally formed with the shaft 30 in the illustrated arrangement. In the illustrated arrangement, the shaft 30, which includes the illustrated disk portion 100, can be made from a simple forging. In other configurations, the disk portion 100 can be separately formed and secured to the shaft 30 in any suitable manner. The disk portion 100 forms one side of the cone shaped valley of the pulley assembly 12 in which the chain 16 is positioned.

The cylinder wall 94 described above forms a portion of a moveable disk 112 that translates along a portion of the input shaft 30. In the illustrated embodiment, the main portion of the moveable disk 112 is interposed between the disk portion 100 of the input shaft 30 and the bulkhead 80. The cylinder wall 94 preferably is integrally formed with the main portion of the moveable disk. As such, the moveable disk 112 preferably is formed as a near net size forging. In other arrangements, the cylinder wall 94 can be formed separately and secured to the moveable disk 112 in any suitable manner. The illustrated arrangement, however, advantageously reduces manufacturing and assembly costs.

The cylinder wall 94 also comprises a spline region 116. The spline region 116 engages the spline region 86 formed on the skirt 84 of the bulkhead 80. Because the cylinder wall 94 moves axially relative to the bulkhead 80, the spline region 116 of the cylinder wall can be substantially shorter in length than the spline region 86 of the skirt 84 of the bulkhead 80. In some arrangements, the spline region 86 of the skirt 84 can be shorter in length than the spline region 116 of the cylinder wall 94.

A cylinder chamber 118 (for a better view, see the output shaft 14) is defined within a region generally bounded by the bulkhead 80, the cylinder wall 94 and the disk portion 100 of the moveable disk 112. This cylinder chamber 118 comprises a pressure chamber into which fluid can be introduced and from which fluid can be evacuated to cause movement of the moveable disk 112 relative to the bulkhead 80. As discussed above, the sliding connection between the skirt 84 and the cylinder wall 94 preferably is sealed by an o-ring or any other suitable sealing component.

The inside diameter of the cylinder wall 94 forms a close tolerance large bearing surface with the bearing region 90 of the bulkhead skirt 84. In addition, a bore defined through an axial center of the moveable disk 112 is sized to form another close tolerance bearing surface relative to the input shaft 30. The interface between the input shaft 30 and the bore through the moveable disk 112 can form a first bearing while the interface between the inner surface of the cylinder wall and the outer surface of the skirt 84 of the bulkhead 80 forms a second bearing.

The two bearings are spaced with the larger diameter portion being positioned away from the chain 16. Together, the two bearings define an ample length to diameter ratio such that the face of the moveable disk 112 that bears against the chain 16 can remain substantially square and concentric without substantial binding or overloading during movement. In most embodiments, this arrangement facilitates movement of the moveable disk 112 even though the disk 112 is subjected to large asymmetric loads by the interface with the chain 16. Pressure changes within the chamber 118 during ratio changes cause the disk 112 to move relative to the bulkhead 80. The movement causes relative movement at the spline regions 86, 116. Because the large diameter bearing is positioned generally adjacent the spline regions 86, 116 in the illustrated arrangement, a tendency for the moveable disk 112 to wobble relative to the axis 46 during combined axial movement and rotational movement is greatly reduced or eliminated. Thus, the large diameter bearing surface forms a dominant alignment feature in the illustrated arrangement.

With reference to FIG. 1, the portions of the housing 20 each comprise a generally annular groove 130. The groove 130 preferably defines a bearing mounting location. In the illustrated arrangement, an outer race 132 of each bearing 110 can be pressed into place within the respective groove 130. As will be discussed below, the illustrated embodiment provides a construction that eliminates most of the significant sources of shaft thrust loading (with the exception of the loads generated by the interaction with the chains) and, therefore, the bearings 110 advantageously can contain what can be termed a full complement of rollers for maximum radial load carrying capability. The bearings 110 preferably require no cage. Instead, the rollers of each bearing 110 can be held in place during assembly with high-viscosity grease. Moreover, as discussed above, the shafts 30 define the inner race for the bearings 110 and no separate inner race is required. In some embodiments, other types and constructions of bearings, with or without inner races, can be used.

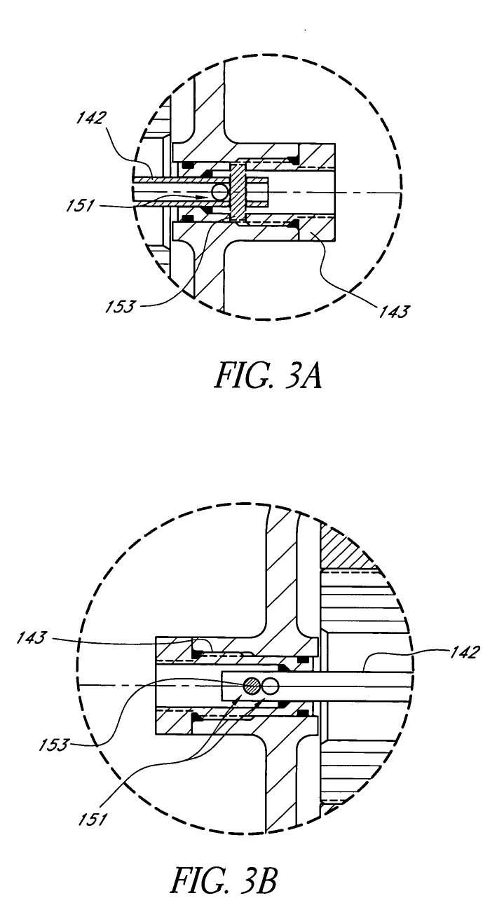

With reference still to FIG. 1, a tube 142 can be secured to the portion of the housing 20 that contains the retaining ring 72. With reference to co-pending U.S. application Ser. No. ______, entitled ______ and filed on an even date herewith, an arrangement is shown and described in which the tube is secured in an inlet port by a compression fitting. This application is hereby incorporated by reference in its entirety. With reference to FIG. 3, the end of the tube 142 can comprise a pair of holes 151 with one of the pair of holes accepting a pin 153 that secures the tube 142 into a fitting and the other of the pair of holes providing a fluid connection between the inside of the tube and the supply of lubricant, hydraulic oil or other suitable fluids. The pin 153 is shown in a generally vertical orientation on the input shaft 12 and in a generally horizontal (e.g., in and out of the paper) orientation on the output shaft 14.

The port fitting 143 to which the tube 142 is secured can extend from a periphery of the housing and can be centrally positioned in the housing along the axis of the shaft. The tube 142 advantageously defines a backbone of a supply gallery 144. The tube 142 preferably is axially positioned in the respective shaft 30. Thus, the tube 142 preferably is positioned along the axial centerline of the respective shaft 30.

During assembly of the illustrated transmission 10, each of the tubes 142 is inserted into a bore in the respective shaft after being assembled to the port fitting 143. This mounting arrangement results in the tubes 142 being restrained against substantial axial or rotational movement relative to the housing 20. As illustrated, the tubes 142 are somewhat cantilevered between the shaft ends 42 and the housing 20 such that some flexing of the tubes 142 is permitted to accommodate small misalignments. In the illustrated arrangement, the pins 153 secure the tubes 142 to the fittings 143 and the pin and fitting assemblies secure the tubes 142 against substantial rotation relative to the housing 20 while allowing some pivotal play to facilitate insertion and alignment. Additionally, the pins 153 limit axial movement of the tubes 142 to very low amounts and may be used to completely prevent such movement.

During operation of the transmission 10, if the tubes 142 are not perfectly concentrically mounted within the shafts 30, the tubes 142 will drag against portions of the bore 144 into which they are inserted and the tubes 142 therefore are expected to wear to some degree over time. Thus, the clearance between the tubes 142 and the bore in which they are inserted is expected to be on the order of about 0.001 inch in the illustrated arrangement. Other clearances can be used to increase or decrease the leakage along the tubes 142. Given the relatively close tolerance, the interaction between the tube 142 and the bore create a structure that can function similar to a labyrinth seal that allows a low leakage rate without the need for sealing rings or other sealing structures. Structures such as labyrinth seals can be used and/or the tolerances can be altered, if desired, to manipulate the leakage rate.

A distal end 146 of the illustrated tube 142 carries a plug 150. The plug 150 closes off the distal end of the tube 142 and, because the tube 142 is not secured to the shaft 30 but is secured to the housing, the tube 142 carries the thrust loading created by the high pressure hydraulic system relative to the housing. As such, no, or very minimal, thrust load is transferred to the shafts from the hydraulic system in the illustrated arrangement. Such an arrangement is advantageous because the bearings supporting the shafts do not need to be chosen to oppose an otherwise large thrust load and the construction of the transmission also is greatly simplified.

Lubricant, hydraulic oil or any other suitable fluid is transmitted from the tube 142 to the chamber 118 via cross holes 152 that penetrate the tube 142 in a region of the respective shaft 30 that contains a radial fluid passage 154 (see output shaft on FIG. 1). The fluid pressure variations that are fed into the chambers 118 via the tubes 142 are used to maintain chain clamping forces and to actuate the moveable disks 112. The radial fluid passage 154 preferably extends between the bore that contains the tube 142 and an outer diameter of the respective shaft 30. The radial fluid passage 154 is axially positioned in a location that generally corresponds to the chamber 118. In the illustrated arrangement, the dimension of the passage 154 in the axial direction of the shaft 30, which preferably is the diameter of the passage 154, is generally defined by the stroke limits of the moveable disk 112. In the illustrated arrangement, a slot 156 provides a fluid connection between the chamber 118 and the passage 154 when the moveable pulley assembly 112 is in its position closest to the bulkhead 80 because the illustrated moveable disk 112 otherwise closes off or substantially closes off the passage. The slot 156 preferably intersects a chamfered edge 160 of the disk 112 such that the fluid communication can be maintained regardless of the angular orientation of the shaft 30.

With continued reference to FIG. 1, a small amount of fluid leakage travels down the bore along the tube 142 to lubricate the interface between the bore and the tube 142. Of this small amount of leakage, some portion exits the shaft 30 via a small passage 162. The fluid passing through the passage 162 lubricates the bearing 110. Another portion of the leakage flows in the opposite direction to lubricate the bearing 66. Yet another portion of the leakage exits through an axial passage 165. The axial passage 165 advantageously slings fluid into the chain for lubrication and cooling.

After lubricating the bearings, the fluid will drop into a sump 180 defined within the housing. The housing 20 also can comprise a baffle 182 that can separate a majority of the sump 180 from the chain 16 such that foaming of the fluid can be reduced. Ports 184 are provided through which fluid pick-up tubes (not shown) can extend. The pick-ups can drain fluid from the sump 180 and return the fluid to a reservoir or the like such that the fluid can be recirculated.

The transmission module 10 described above has been designed particularly for use in motor vehicle applications, such as sport utility vehicles and medium size trucks, vans, buses, and the like. Such vehicles have ground clearances and/or frame designs that can accept an offset drive shaft. For instance, in one arrangement, the offset is on the order of about nine inches. The transmission can be adapted for other applications, if desired, and the offset can be vertical, horizontal or any angle in between. Moreover, the illustrated embodiment of the present invention disclosed herein is capable of transferring input torques in excess of 750 Newton meters (N.m) and can function with a ratio spread in excess of 5 to 1.

Notwithstanding the vehicles for which the module 10 was originally designed, the transmission module 10 can be used in other applications. The transmission module 10 comprises a stepless ratio changing drive module that can be used in conjunction with any of a number of input and output devices to define a complete transmission that can be used in a variety of different applications. For instance, the transmission module 10 can be coupled with a torque converter or the like. Alternatively, the transmission module 10 can be directly coupled to an input shaft and an output shaft such that the transmission module 10 defines the entire transmission.

Although the present invention has been described in terms of a certain embodiment, other embodiments apparent to those of ordinary skill in the art also are within the scope of this invention. Thus, various changes and modifications may be made without departing from the spirit and scope of the invention. For instance, various components may be repositioned as desired. Moreover, not all of the features, aspects and advantages are necessarily required to practice the present invention. Accordingly, the scope of the present invention is intended to be defined only by the claims that follow.

What is claimed is:

1. A continuously variable transmission comprising a housing, a first pulley assembly and a second pulley assembly supported within said housing, a chain extending between said first pulley assembly and said second pulley assembly, said first pulley assembly comprising a first shaft and a first bulkhead, said first shaft comprising a first disk portion, a first moveable disk being positioned between said first bulkhead and said first disk portion, said second pulley assembly comprising a second shaft and a second bulkhead, said second shaft comprising a second disk portion, a second moveable disk being positioned between said second bulkhead and said second disk portion, said first bulkhead being secured to said first shaft such that said first bulkhead is substantially secured against rotation relative to said first shaft, said second bulkhead being secured to said second shaft such that said second bulkhead is substantially secured against rotation relative to said second shaft, a first outer bearing surface being defined between said first moveable disk and said first bulkhead and a first inner bearing surface being defined between said first moveable disk and said first shaft, a second outer bearing surface being defined between said second moveable disk and said second bulkhead and a second inner bearing surface being defined between said second moveable disk and said second shaft, a first spline connection being located between said first outer bearing surface and said first inner bearing surface, a second spline connection being located between said second outer bearing surface and said second inner bearing surface, a first fluid passage extending axially through at least a portion of said first shaft and a second fluid passage extending axially through at least a portion of said second shaft, a first fluid tube extending at least part way through said first fluid passage and a second fluid tube extending at least part way through said second fluid passage, and a first end of the first fluid tube containing a first plug and a first end of the second fluid tube containing a second plug.

2. The transmission of claim 1, wherein said first spline connection comprises a first bulkhead spline and a first moveable disk spline.

3. The transmission of claim 2, wherein said first bulkhead spline is located on a first skirt of said first bulkhead.

4. The transmission of claim 3, wherein said first bulkhead spline is located on an outer surface of said first skirt.

5. The transmission of claim 2, wherein said first moveable disk spline is located on a cylinder wall of said first moveable disk.

6. The transmission of claim 5, wherein said first moveable disk spline is located on an inner surface of said cylinder wall.

7. The transmission of claim 1 further comprising a first plurality of pins that rotationally secure said first bulkhead to said first shaft.

8. The transmission of claim 7, wherein said first shaft comprises a step with a radial face and said first plurality of pins are partially positioned in bores formed in said radial face and partially position in said first bulkhead.

9. The transmission of claim 1 further comprising a first chamber at least partially defined by said first bulkhead and said first moveable disk and a first radial passage extending from said first fluid passage to said first chamber.

10. The transmission of claim 9, wherein said first fluid tube comprises an opening proximate to said first fluid passage.

11. The transmission of claim 1 further comprising a small passage extending from said first fluid passage to an outer surface of said first shaft, said first plug being positioned between an inlet to said first fluid tube and an intersection of said small passage and said first fluid passage.

12. The transmission of claim 1 wherein said first shaft comprises a journal surface, a bearing is mounted about said journal surface, and said journal surface forms an inner race of said bearing.

13. A continuously variable transmission comprising a housing, a first pulley assembly and a second pulley assembly supported within said housing, a chain extending between said first pulley assembly and said second pulley assembly, said first pulley assembly comprising a shaft and a bulkhead, said shaft comprising a disk portion, a moveable disk being positioned between said bulkhead and said disk portion, said bulkhead being secured to said shaft such that said bulkhead is substantially secured against rotation relative to said shaft, an outer bearing surface being defined between said moveable disk and said bulkhead and an inner bearing surface being defined between said moveable disk and said shaft, a spline connection being located between said outer bearing surface and said inner bearing surface.

14. The transmission of claim 13, wherein said spline connection comprises a bulkhead spline and a moveable disk spline.

15. The transmission of claim 14, wherein said bulkhead spline is located on a skirt of said bulkhead.

16. The transmission of claim 15, wherein said bulkhead spline is located on an outer surface of said skirt.

17. The transmission of claim 14, wherein said moveable disk spline is located on a cylinder wall of said moveable disk.

18. The transmission of claim 17, wherein said moveable disk spline is located on an inner surface of said cylinder wall.

19. The transmission of claim 13 further comprising a plurality of pins that rotationally secure said bulkhead to said shaft.

20. The transmission of claim 19, wherein said shaft comprises a step with a radial face and said plurality of pins are partially positioned in bores formed in said radial face and partially position in said bulkhead.

21. The transmission of claim 13 wherein said shaft comprises a journal surface, a bearing is mounted about said journal surface, and said journal surface forms an inner race of said bearing.

22. A continuously variable transmission comprising a housing, a first pulley assembly and a second pulley assembly supported within said housing, a chain extending between said first pulley assembly and said second pulley assembly, said first pulley assembly comprising a shaft and a bulkhead, said shaft comprising a disk portion, a moveable disk being positioned between said bulkhead and said disk portion, a fluid passage extending axially through at least a portion of said shaft, a fluid tube extending at least part way through said fluid passage and a first end of the fluid tube containing a plug.

23. The transmission of claim 22 further comprising a chamber at least partially defined by said bulkhead and said moveable disk and a radial passage extending from said fluid passage to said chamber.

24. The transmission of claim 23, wherein said fluid tube comprises a side opening proximate to said fluid passage.

25. The transmission of claim 22 further comprising a small passage extending from said fluid passage to an outer surface of said shaft, said plug being positioned between an inlet to said fluid tube and an intersection of said small passage and said fluid passage.

26. The transmission of claim 25, wherein said small passage extends outward from said fluid passage to said outer surface at an angle.

27. The transmission of claim 26, wherein said angle is a right angle and said small passage is located axially along said shaft proximate said chain.

28. The transmission of claim 27 further comprising a second small passage extending from said fluid passage to an outer surface of said shaft, said second small passage extending outward at an angle and having an end proximate an end of said shaft.
